(19) United States
(12) Patent Application Publication
(10) Pub. No.: US 2015/0375791 A1
(43) Pub. Date: Dec. 31, 2015

(54) PICKUP TRUCK CAB WITH E-COAT HOLES

(71) Applicant: FORD GLOBAL TECHNOLOGIES, LLC, Dearborn, MI (US)

(72) Inventors: Srinath VIJAYAKUMAR, (US); David Edward PAUL, (US); Elizabeth THEECK, (US); Kamal FOANI, (US); Azaz KHATRI, (US)

(21) Appl. No.: 14/317,300

(22) Filed: Jun. 27, 2014

(51) Int. Cl. B62D 25/20; B62D 65/02; C25D 13/12; C23C 18/54

(52) U.S. Cl. CPC B62D 25/20; C23C 18/54; B62D 65/02; C25D 13/12

(57) ABSTRACT

A floor pan for a body-in-white vehicle includes a front seat footwell portion and a rear seat footwell portion. The front seat footwell portion defines a front fluid passage hole for porting a surface treatment liquid during submersion of the floor pan in a surface treatment bath. The rear seat footwell portion defines a rear fluid passage hole for porting the surface treatment liquid during submersion of the floor pan in the bath.

### TECHNICAL FIELD

The present disclosure relates to body-in-white pickup truck floor pans that include holes for facilitating the flow of e-coat liquids.

### BACKGROUND

Pickup trucks are motor vehicles with a rear open top cargo area that is often referred to as a cargo box. Pickup trucks are popular largely because the bed allows the vehicle to be utilized in many different ways, including caring a variety of types of cargo and towing various types of trailers. Traditionally, the majority of body structures on pickup trucks have been formed from steel alloys. Through years of experience, pickup truck designers have learned how to design steel truck body parts that withstand the variety of demanding pickup truck applications. The current regulatory and economic environment have increased the importance of making pickup trucks more fuel efficient while maintaining or improving functionality and durability. One way to reduce the fuel consumption of a vehicle is to reduce vehicle structure weight.

Aluminum alloys typically have a higher strength to weight ratio than steel alloys. Consequently, replacing steel with aluminum offers the potential for weight reduction. However, the elastic modulus of aluminum is generally lower than elastic modulus of steel. Additionally, fabrication techniques and methods for joining parts that work well for steel parts may not work well for the same aluminum part. Due to these and other differences, simple material substitution does not necessarily produce acceptable design.

Aluminum alloys are generally identified by a four digit number, the first digit of which typically identifies the major alloying element. When describing a series of aluminum alloys based on the majority alloying element, the first number may be followed by three x's or three zero's. For example, the major alloying element in 6xxx (or 6000) series aluminum alloy is magnesium and silicone, while the major alloying element of 5xxx series is magnesium and for 7xxx series is zinc. Additional numbers represented by the letter ‘x’ (or zero) in the series designation define the exact aluminum alloy.

### SUMMARY

According to an aspect of the present disclosure, a floor pan for a body-in-white vehicle includes a front seat footwell portion and a rear seat footwell portion. The front seat footwell portion defines a front fluid passage hole configured to port a surface treatment liquid during submersion of the floor pan in a surface treatment bath. The rear seat footwell portion defines a rear fluid passage hole configured to port the surface treatment liquid during submersion of the floor pan in the bath.

According to an another aspect of the present disclosure, a method of submerging a body-in-white vehicle into a tank containing surface treatment liquid is disclosed. The method includes forming at least one front footwell hole and at least one rear footwell hole into a floor pan of the vehicle. Then conveying the vehicle into the tank and porting the liquid initially through the front hole and subsequently through the rear hole to reduce the buoyancy of the vehicle and increase a sinking rate of the vehicle.

### BRIEF DESCRIPTION OF THE DRAWINGS

FIG. 1 is a perspective view of an e-coating line.

FIG. 2 is a side elevation view of the e-coating line of FIG. 1 illustrating the potential floating problem associated with lighter weight pickup trucks.

FIG. 3 is a plan view of a floor pan of a pickup truck cab according to one embodiment.

FIG. 4 is a fragmentary plan view of a floor pan illustrating a race track according to one embodiment.

FIG. 5 is a cross-sectional view of FIG. 4 along cut 5-5.

FIG. 6 is a cross-sectional view similar to FIG. 5 illustrating a cap assembled to the floor pan to cover the hole.

FIG. 7 is a flowchart illustrating one method for e-coating a vehicle.

FIG. 8 is a flowchart illustrating another method for e-coating a vehicle.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

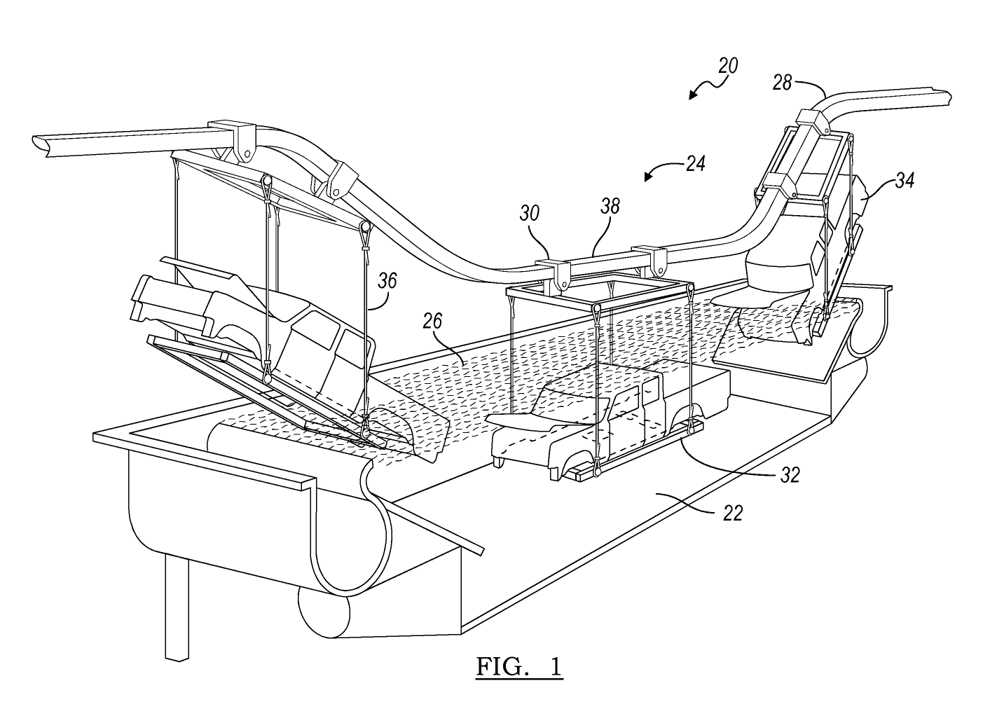

Referring to FIG. 1, an e-coating line 20 includes a tank 22 and a vehicle conveying system 24. The tank 22 contains a surface treatment liquid 26. For example, the surface treatment liquid 26 may be paint, primer, or zinc phosphate. The conveying system 24 may include a guild rail 28 and a plurality of carriages 30. Each carriage 30 is attached to the rail 28 and is conveyed along the rail. A skid 32 may be attached to a body-in-white vehicle 34 on an underside of the vehicle. A plurality of chains 36 may connect each skid 32 to each carriage 30 to suspend the vehicle under the rail 28. The skid 32 supports the vehicle 34 and allows the vehicle to be suspended under and move along the rail 28 via the carriages 30. The body-white-vehicle 34 may be a pickup truck that includes aluminum alloy body structures. The guide rail 28 may include a valley portion 38 that cooperates with the tank 22 to dip the vehicle 34 into the tank 22 and submerge the vehicle 34 in the surface treatment liquid 26. During e-coating, an electric charge is applied to the surface treatment liquid causing the colloidal particles in the surface treatment liquid to migrate, condense and adhere to the vehicle 34. This process allows all surfaces of the vehicle 34 to be covered with a strongly adhered layer of surface treatment. Other e-coating processes are contemplated within the scope of the present disclosure; for example the vehicle (rather than the liquid) can be supplied with the electric charge.

Once the surface treatment is applied, the vehicle is removed from the tank 22 and excess liquid is drained from the vehicle back into the tank 22. The vehicle 34 then enters a bake oven to cure the surface treatment liquid.

For successful e-coating, the vehicle 34 must be fully submerged within the surface treatment liquid. E-coating lines may rely on vehicle weight for sinking the vehicle and may not apply an external downward force to the vehicle. E-coating line 20, for example, includes chains 36 and relies on vehicle weight for submersion. The line speed for the e-coating line 20 is partially dependent upon the time required to fully immerse the vehicle, also known as “sinking time”. If the sinking time increases, the line speed must be slowed down to account for this increased sinking time reducing efficiency and productivity of the line. Buoyancy of the vehicle is caused by air pockets and displacement of the liquid as the vehicle is immersed. Buoyancy is also affected by the viscosity of the surface treatment liquid.

Vehicle weight is one factor that affects buoyancy. A lighter vehicle has increased buoyancy as compared to a heavier vehicle if all other factors remain constant. The demand for lightweight vehicles has increased due to increasing emphasis on fuel efficiency. For example, the pickup truck 34 may include aluminum alloy body structures in order to decrease the weight of the pickup truck. Aluminum alloy pickup trucks may have increased fuel efficiency and driving dynamics but may also cause several problems during the e-coating process.

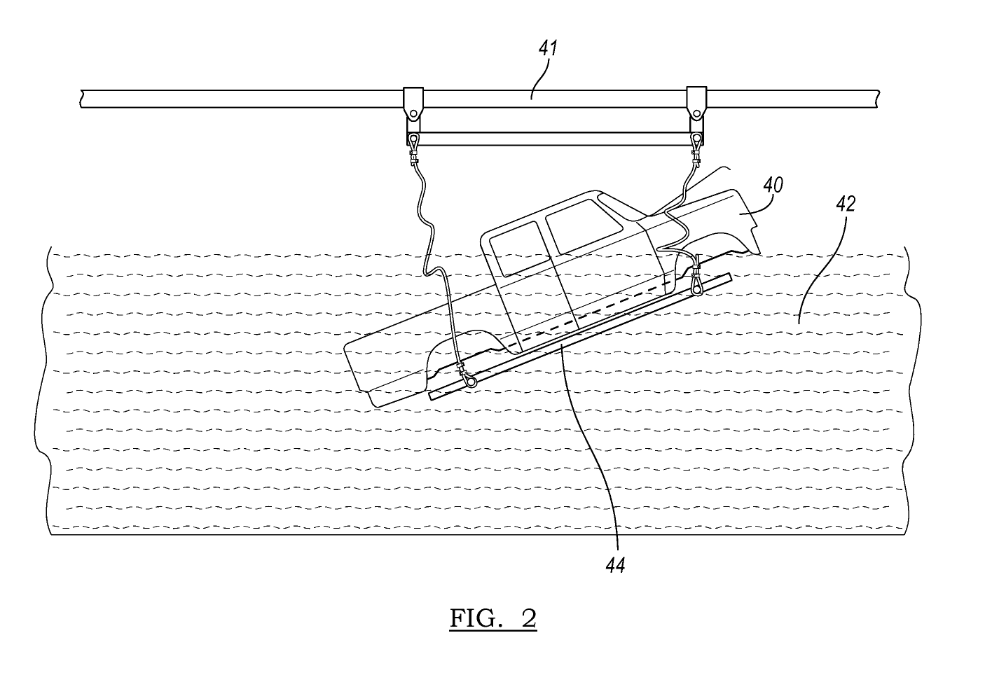

FIG. 2 illustrates one potential e-coating problem with an aluminum alloy pickup trucks. The aluminum alloy pickup truck 40 may weigh several hundred pounds less than a traditional steel pickup truck and have an increased buoyancy. This increased buoyancy may cause the pickup truck 40 to float for a longer period of time in the surface treatment liquid 42 before sinking towards the bottom of the tank. Damage to the line equipment 41 and the truck 40 may occur if the truck floats. For example, the truck 40 may hit into the line equipment 41 causing damage to the line equipment and the truck. Increasing the vehicle weight could help to alleviate this problem but would negate the advantages of an aluminum alloy truck. The weight of the skid 44 could be increased to help alleviate this problem, but increasing the weight of the skid 44 requires retooling, puts more stress on the line equipment 41 and increases energy usage to run the line.

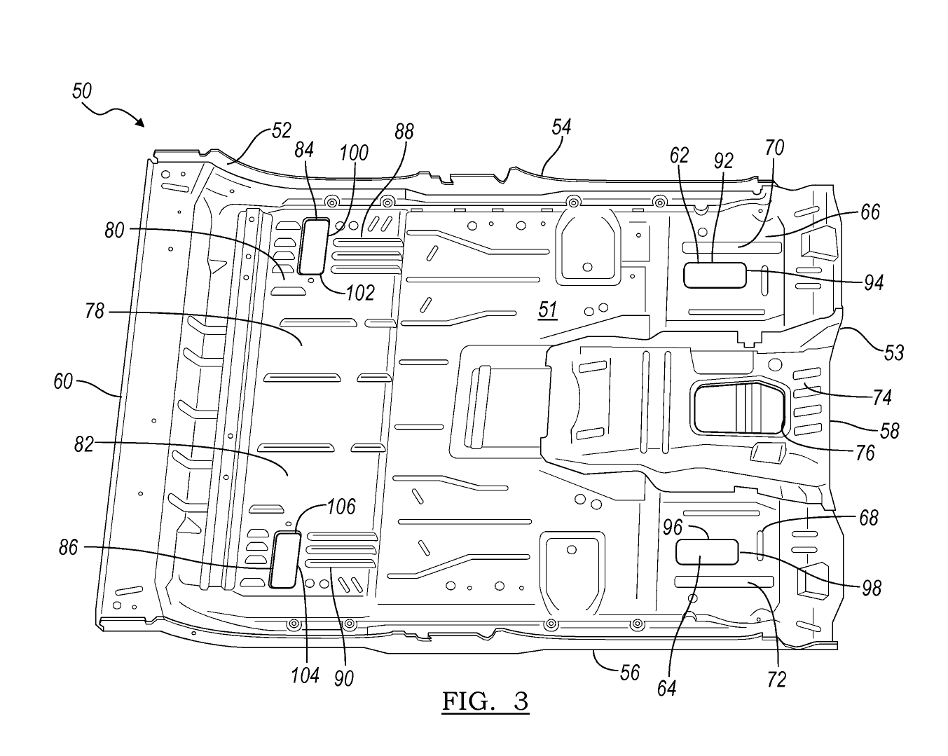

Referring to FIG. 3, a portion of the vehicle 50 is shown illustrating a plan view of the floor pan 52. The floor pan 52 includes an interior surface 51 and an exterior surface 53 that is opposite the interior surface 51. The floor pan 52 also includes a driver longitudinal side 54 and an opposing passenger longitudinal side 56. The floor pan 52 also includes a front area 58 and a rear area 60.

The floor pan 52 includes a driver footwell portion 66 that defines a driver side fluid passage hole, or “driver hole” 62. The driver hole 62 extends between the interior surface 51 and the exterior surface 53 forming a hole completely through the floor pan 52. The floor pan 52 may also include a passenger footwell portion 68 that defines a front passenger side fluid passage hole, or “passenger hole” 64. The passenger hole 64 extends between the interior surface 51 and the exterior surface 53 forming a hole completely through the floor pan 52. A transmission tunnel 74 may be disposed between the driver footwell portion 66 and the passenger footwell portion 68 and approximately located along a longitudinal centerline of the floor pan 52. In the illustrated embodiment, the transmission tunnel defines a transmission tunnel hole 76, but this may not be essential.

A plurality of beads 70 may be formed in the floor pan 52 around the driver hole 62 to compensate for reduced strength due to the creation of the hole 62. A plurality of beads 72 may be formed in the floor pan 52 around the front passenger hole 64 to compensate for reduced strength due to the creation of the hole 64. The configuration and the number of the beads 70, 72 will depend upon the size of the hole and specific design requirements of the floor pan 52. This disclosure contemplates a plurality of different bead configurations.

The floor pan 52 also includes a rear footwell portion 78. The rear footwell portion 78 may include a driver-side area 80 and a passenger-side area 82. The driver-side area 80 may define a first fluid passage hole, or “first hole” 84. The first hole 84 extends between the interior surface 51 and the exterior surface 53 forming a hole completely through the floor pan 52. The passenger-side area 82 may define a second fluid passage hole, or “second hole” 86. The second hole 86 extends between interior surface 51 and the exterior surface 53 forming a hole completely through the floor pan 52. A plurality of beads 88 may be formed in the floor pan 52 around the first hole 84 to compensate for reduced strength due to the creation of the hole 84. A plurality of beads 90 may be formed in the floor pan 52 around the second hole 86 to compensate for reduced strength due to the creation of the hole 86.

Each of the holes includes a length and a width. If the length is larger than the width it may be referred to as an “elongated rectangular hole”. For example, each hole may be an elongated rectangle that is 192 millimeters (mm) long and 82 mm wide. In another embodiment, the rectangular holes may be between 175 mm-210 mm long and may be between 60 mm-100 mm wide. The length 92 of the driver hole 62 is parallel to the driver longitudinal side 54 of the floor pan 52. The width 94 of the driver hole 62 is parallel to the front 58 of the floor pan 52 and substantially perpendicular to the driver longitudinal side 54.

The length 96 of the passenger hole 64 is parallel to the passenger longitudinal side 56 of the floor pan 52. The width 98 of the front hole 64 is parallel to the front area 58 of the floor pan 52 and perpendicular to the passenger longitudinal side 56.

The length 100 of the first hole 84 is perpendicular to the driver longitudinal side 54 of the floor pan 52. The width 102 of the first holes 84 is perpendicular to the rear 60 of the floor pan 52 and parallel to the driver longitudinal side 54.

The length 104 of the second hole 86 is perpendicular to the passenger longitudinal side 56 of the floor pan 52. The width 106 of the second hole 86 is perpendicular to the rear area 60 of the floor pan 52 and parallel to the passenger longitudinal side 54. The present disclosure contemplates other orientations of holes 62, 64, 84 and 86.

FIG. 3 illustrates the front holes 62, 64 and the rear holes 84, 86 being rotated 90° with respect to each other. Other arrangements may be provided may be provided, for example, the holes could all be aligned at the same orientation. The holes may also be arranged such that each hole has a different orientation. The holes may be rectangular, square, circular or any other suitable shape.

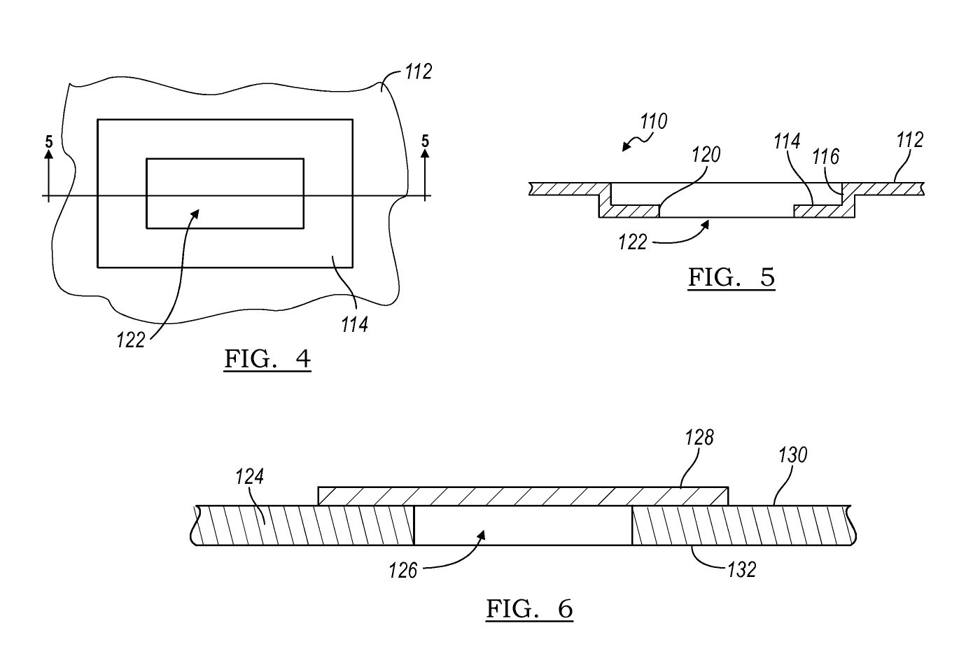

In some embodiments, a recessed area, or “racetrack” may be disposed around at least one of the holes. The racetrack provides additional strength to reinforce the area around the hole and also allows the hole to be covered to provide a smooth surface as will be described below. FIGS. 4 and 5 illustrate a portion of the floor pan around one of the holes. The floor pan includes a main surface 112 and a recessed surface 114. The recessed surface 114 defines the racetrack 110. The main surface 112 and the recessed surface 114 are joined together by a step 116. The step 116 defines the periphery of the racetrack 110. The racetrack 110 also includes an edge 120 that defines the periphery of the hole 122.

After the vehicle is surface treated, the holes may be covered to seal the floor pan. Referring to FIG. 6, a floor pan 124 may include at least one hole 126. A cap 128 is assembled over the hole 126 to seal the hole. The cap 128 may be attached to the interior surface 130 of the floor pan 124. Alternatively, the cap 128 may be attached to the exterior surface 132 of the floor pan 124. The cap 128 may be welded, bolted or otherwise permanently attached to the floor pan 124. The cap 128 may be a metallic pad, a stamped sheet, a metal part, a composite panel, or other durable, rigid part.

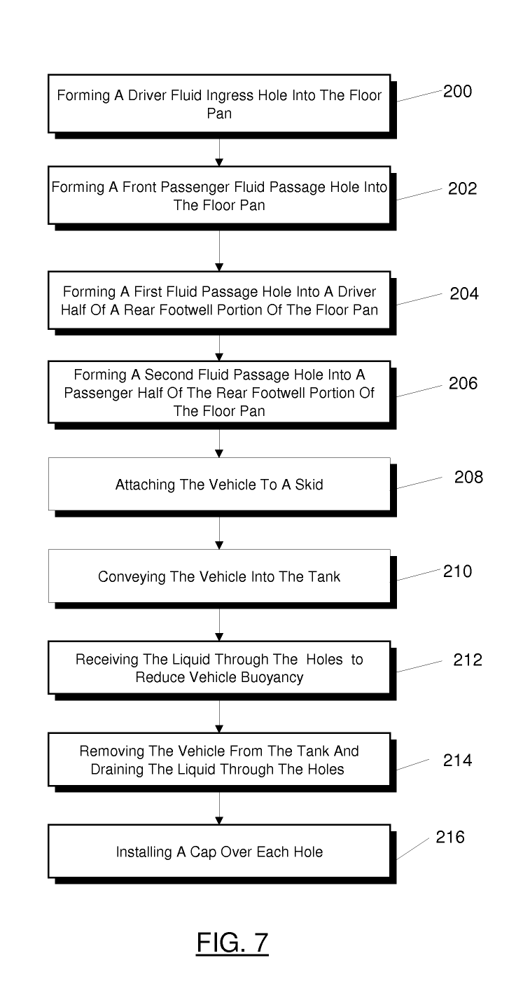

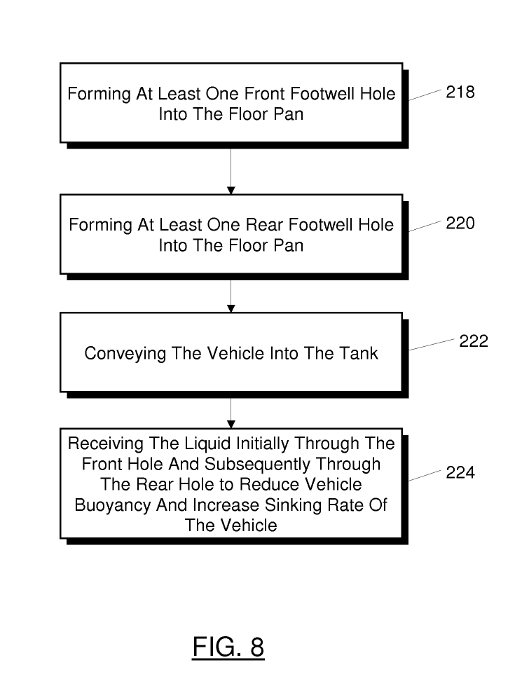

FIG. 7 illustrates a flow chart describing one method for e-coating a vehicle. The method will be described with reference to FIG. 3. At least one front footwell hole is formed in the floor pan 52 of the vehicle 34. The driver hole 62 is formed in the driver footwell portion 66 of the floor pan 52 at step 200. The passenger hole 64 is formed in the front passenger footwell portion 68 of the floor pan 52 at step 202. The first hole 84 is formed in the driver-side area 80 of the rear footwell portion 78 at step 204. The second hole 86 is formed in the passenger-side area 82 of the rear footwell portion 78 step 206. As an alternative, a transmission hole 76 may be formed into the transmission tunnel 74 to further reduce buoyance of the vehicle. The fluid passage holes may be formed by stamping, cutting, or other conventional techniques.

The body-and-white vehicle 34 is attached to a skid 32 at step 208 after the fluid passage holes are formed. The skid 32 supports the vehicle 34 during the e-coat dipping process and conveys the vehicle along the line 20. At step 210, the vehicle is conveyed forward along the guide rail 28 and is dipped into the tank 22.

As the vehicle 34 enters the tank 22 the surface treatment liquid 26 is initially received through the driver hole 62 and the passenger hole 64 at step 212. The liquid 26 may also be received through the transmission hole 76. The fluid passage holes allow the liquid 26 to enter into the vehicle 34 more quickly and reduce the buoyancy of the vehicle 34. The aluminum alloy components may reduce the vehicle weight so much that the vehicle 34 tends to float. The addition of the fluid holes allows the surface treatment liquid 26 to enter into the vehicle 34 immediately and reduce the tendency of the vehicle to float. As the vehicle moves further into the tank 22, the liquid 26 enters into the vehicle through the first and second holes 84, 86 to further reduce the buoyancy of the vehicle. The holes cooperates to prevent the vehicle 34 from floating and also increase the sinking rate of the vehicle 34. Preventing floating minimizes the potential for the vehicle to become detached from its carriage 30 and cause damage to the line. The increased sinking rate allows for increased line speed.

The vehicle 34 is conveyed out of the tank 22 after the surface treatment is fully applied. The surface treatment liquid 26 inside the vehicle 34 drains through the fluid passage holes (62, 64, 84, 86) at step 214 and reduces the time required to fully drain the surface treatment liquid 26 from the vehicle 34. At step 216, a cap is installed over each hole to seal the floor pan 52.

In another embodiment, the method is simplified to include forming at least one front footwell hole into the floor pan at step 218. At step 220, at least one rear footwell hole is formed into the floor pan of the vehicle. After forming the holes, the vehicle is conveyed into the tank containing the surface treatment liquid at step 222. When the vehicle enters the tank, surface treatment liquid is initially received through the front hole and subsequently received through the rear hole at step 224. The holes allow liquid to enter into the cab of the vehicle to reduce buoyancy and increase the sinking rate of the vehicle.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1.-8. (canceled)

9. A method of processing a body-in-white vehicle comprising:
forming at least one front footwell hole and at least one rear footwell hole into a floor pan of the vehicle; and
conveying the vehicle into a tank containing a surface treatment liquid such that the liquid is ported initially through the front hole and subsequently through the rear hole to reduce buoyancy of the vehicle and increase a sinking rate of the vehicle into the liquid.

10. The method of claim 9 further comprising attaching the vehicle to a skid.

11. The method of claim 9 further comprising removing the vehicle from the tank such the liquid is drained through each of the holes to remove the liquid from inside the vehicle.

12. The method of claim 9 further comprising installing a cap over each of the holes after completion of surface treatment.

13. The method of claim 9 wherein the front footwell hole and the rear footwell holes are rectangular and each include a length dimension and a width dimension, and wherein the length dimension is longer than the width dimension.

14. The method of claim 13 wherein the front footwell hole is formed such the length dimension is parallel to longitudinal sides of the floor pan.

15. The method of claim 14 wherein the rear footwell hole is formed such that the width dimension is parallel to the longitudinal sides of the floor pan.

16. The method of claim 9 wherein the at least one front footwell hole further includes a driver fluid passage hole and a front passenger fluid passage hole.

17. The method of claim 9 wherein the at least one rear footwell hole further includes a first footwell hole defined in a driver-side area of a rear seat footwell portion and a second footwell hole defined in a passenger-side area of the rear seat footwell portion.

18. The method of claim 9 further comprising:
forming at least one front reinforcement bead adjacent to the front footwell hole; and
forming at least one rear reinforcement bead adjacent to the rear footwell hole.

19. The method of claim 9 further comprising:
forming a front recess around a peripheral edge of the front footwell hole; and
forming a rear recess around a peripheral edge of the rear footwell hole.

20. The method of claim 9 further comprising:
forming a transmission hole in a transmission tunnel to port the surface treatment liquid through the floor pan during submersion of the vehicle.
